(19) United States
(12) Patent Application Publication
(10) Pub. No.: US 2010/0096389 A1
(43) Pub. Date: Apr. 22, 2010

(54) SANITARY TRASH RECEPTACLE AND METHOD OF OPERATION THEREOF

(76) Inventors: Laura C. Volpe, Commack, NY (US); Marco Branchinelli, Port Jefferson Station, NY (US)

Correspondence Address: THORNE & HALAJIAN;APPLIED TECHNOLOGY CENTER, 111 WEST MAIN STREET, BAY SHORE, NY, 11706, US

(21) Appl. No.: 12/253,041

(22) Filed: Oct. 16, 2008

Related U.S. Application Data
(60) Provisional application No. 60/999,185.

(51) Int. Cl. B65D 25/00; B08B 7/00

(52) U.S. Cl. 220/501; 134/42

(57) ABSTRACT

A refuse receptacle apparatus, including a first part having one or more walls defining at least part of a first cavity, a longitudinal axis, and first and second openings situated opposite each other such that the longitudinal axis passes through the first and second openings. The apparatus may also include a second part having one or more walls defining at least part of a second cavity and configured to support at least part of the first part and to cover the second opening. A screen may be situated between the first and second cavities and supported by the first or second parts.

### CROSS-REFERENCE TO RELATED APPLICATION.

This application claims the benefit of U.S. Provisional Patent Application No. 60/999,185, filed Oct. 16, 2007.

### FIELD OF THE PRESENT SYSTEM

The present system relates generally to trash bins and, more particularly, to modular trash bins with removable components to aid cleaning and deodorization thereof, and a method of operation thereof.

### BACKGROUND OF THE PRESENT SYSTEM

Typically, trash bins are used to store refuse prior to removal and disposal. A standard household trash bin comprises a molded plastic or metal container with one or more walls and a bottom which is integrally molded to the one or more walls and have a capacity that generally ranges from 10 gallons, for an indoor trash bin, to about fifty-five gallons, for a larger outdoor trash bin. In standard disposal conditions, refuse typically leaks and/or may be placed directly into the trash bin prior to removal and disposal. Accordingly, depending upon conditions in which the conventional trash bins are stored, unsanitary conditions typically develop within their interiors. This may be undesirable, unsanitary, and lead to a foul odor emanating from the trash bin. Further, these conditions are exacerbated when the trash bin is placed outdoors where it is affected by environmental factors such as sunlight and/or ambient heat. Further, when exposed to the environment, rain and/or snow may accumulate within the trash bin which may be difficult to remove and may further exacerbate unsanitary conditions.

Accordingly, conventional trash bins must be cleaned from time to time to reduce or eliminate those undesirable conditions. However, because prior trash bins have an integral bottom portion, they are difficult to properly clean. For example, a typical trash bin must be hosed down and tipped to its side or turned upside down to drain wash water from within. This process is messy and difficult to perform in a household environment. Additionally, in attempts to clean a bottom portion of the trash bin, water typically splashes outward making cleaning even more difficult and unpleasant.

Although some trash bins are equipped with drains, these drains are insufficient to properly drain wash water from the trash bin after it has been washed. Further, because water weighs about seven pounds per gallon, even a small kitchen trash bin (e.g., with about a ten plus gallon capacity) which is filled with wash water may not be easily handled.

Further, although there have been attempts to provide improved trash bins these trash bins fall short of the features and advantages of the present system. For example, several prior art designs show trash bins in which trash is removed via a bottom opening. For example, U.S. Pat. No. 6,253,949 entitled “BOTTOMLESS TRASH CAN SYSTEM,” to R. Dickson (hereinafter “Dickson”), incorporated herein as if set out in its entirety, shows a bottomless trash can system that uses a bottomless trash can with tapered walls and a drip pan to receive liquid waste. In operation, the trash can is lifted to remove it from a trash liner. Accordingly, disadvantages include a trash liner which rests on the drip pan and may soak in fluids in the drip pan, which is undesirable and unsanitary. Further disadvantages include possible tracking of fluids by a trash liner which is removed from the trash bin, increased complexity, and additional steps required to remove trash, all of which make removing the trash more difficult and time consuming.

Similarly to Dickson, U.S. Pat. No. 4,961,514 entitled “REFUSE BINS” to T Palmer (Palmer), incorporated herein as if set out in its entirety, shows a refuse bin having tapered walls and a base. The refuse bin is removed from refuse contained within by lifting it off the base so as to leave an inner container (e.g., a liner) exposed. Disadvantages of this design are similar to those of Dickson.

Further, U.S. Pat. No. 2,817,476 entitled “BOTTOM OPENING GARBAGE CAN,” to E. Mills (Mills), also teaches a bottom opening garbage can with tapered walls and a drip pan to receive liquid waste. Similarly to the above-referenced patents, trash contained in the trash bin is removed via a bottom opening such that the trash bin does not have to be manually upended. To remove trash from trash bin, the trash bin is lifted and a bottom closure opened so as to allow the trash to fall out of the bottom opening. Similarly to the other prior trash bins, disadvantages include a design that requires resting trash on the bottom of the trash bin which may exacerbate unsanitary conditions. Further, a user must manipulate a thumb-piece while holding the trash bin so as to remove trash which is inconvenient. Further, by opening the lower opening while the trash bin is lifted, the lower opening may dissipate spills which is undesirable.

Similarly, U.S. Pat. No. 3,370,787 entitled “BAG-LINED GARBAGE RECEPTACLE,” to W. Lindholm (Lindholm), incorporated herein as if set out in its entirety, shows a garbage receptacle which uses a bottom opening (which is closed using a base) to remove a filled (trash) bag contained within the receptacle. This design suffers a disadvantage in that trash present in the trash bin rests on the bottom of the trash bin and, therefore, may absorb liquids which are present in the base of the receptacle.

U.S. Pat. No. 1,985,508 entitled “SANITARY GARBAGE CAN” to L. Lasel (Lasel), incorporated herein as if set out in its entirety, shows a trash bin which uses a bottom opening and a tray for sealing this opening. As shown in FIG. 2 of Lasel, a paper liner absorbs liquids which are present on the bottom tray. However, as the trash rests upon the bottom tray, the trash may absorb unsanitary liquids present at the bottom of the trash bin which may be undesirable.

Accordingly, there is a need for a trash bin which may be easily cleaned and/or deodorized when desired.

Further, there is a need for a trash bin which separates fluids from other contents of the receptacle.

### SUMMARY OF THE PRESENT SYSTEM

Therefore, it is an object of the present system to solve the above-noted problems and other problems of conventional trash bins and to provide a modular trash bin which may be easily cleaned and deodorized. It is envisioned that the trash bin may be used in an indoor environment (e.g., in a kitchen, etc.) or in an outdoor environment (e.g., to temporarily store and/or transport trash for disposal).

Therefore, it is a further object of the present system to provide a refuse container which may keep fluids located at the bottom of the container from being absorbed by or mixed with other contents of the receptacle.

Accordingly, there is disclosed a refuse receptacle apparatus, including a first part having one or more walls defining at least part of a first cavity, a longitudinal axis, and first and second openings situated opposite each other such that the longitudinal axis passes through the first and second openings. The apparatus may also include a second part having one or more walls defining at least part of a second cavity and configured to support at least part of the first part and to cover the second opening. The apparatus may further include a screen situated between the first and second cavities and supported by the first or second parts.

According to the present system, the screen may hingedly attached to the first or second parts or may be formed integrally with the first part. Further, other screens may be included which may be fixedly and/or hingedly located.

The apparatus may further include an axle attached to the first part, and one or more wheels attached to the axle. Moreover, one or more of the screens may rotate about an axis of the axle. A holding member may be included and may be attached to the first or second parts and which may support at least part of the screen. The holding member may be formed integrally with the first part and/or may also include a rod which is attached to the first part.

The apparatus may further include a cover configured to cover the first opening and an optional foot pedal which may transmit a force for opening the cover.

Moreover, the apparatus may include one or more latches which may releasably secure the second part in a closed position relative to the first part. One or more of the latches may include a saddle which is depressed to release the first and second parts from each other.

According to another aspect of the present system, there is disclosed a receptacle apparatus which includes a first part having one or more walls defining at least part of a first cavity, a longitudinal axis, and first and second openings situated opposite each other such that the longitudinal axis passes through the first and second openings. The receptacle apparatus may included a second part hingedly attached to the first part and having one or more walls defining at least part of a second cavity, the second part being configured to support at least part of the first part and to cover the second opening. Further, the receptacle apparatus may include a screen attached to the first part. Moreover, the receptacle apparatus may include a latch attached to one or more of the first and second parts and is configured to hold the second part in a closed position relative to the first part.

According to the present system, the one or more walls of the first part may define a taper in the first part such that the second opening is smaller than the first opening. Moreover, the apparatus may include one or more vent holes situated in the one or more walls of the second or second parts so as to prevent a vacuum from forming when inserting and/or removing objects (e.g., garbage bags, liners, etc.) from the first cavity.

Moreover, the receptacle apparatus may further include an axle attached to the first part, and one or more wheels attached to the axle. The receptacle apparatus may further include a saddle configured to support the axle. The saddle may be situated, at least in part, between the wheels and may be formed, at least in part, integrally with the first part. The saddle may provide a base for supporting the weight of the receptacle apparatus and/or contents thereof.

Moreover, it is yet another aspect of the present system to provide a method for cleaning a trash bin having a body supported by a plurality of wheels mounted to an axle, the body defining a cavity having first and second openings located opposite each other, and first and second covers which respectively cover first and second openings, the method may include one or more of the acts of depressing an attaching device which releasably attaches the second cover to the body so as to release the body portion from the second cover. Further the method may include the act of rotating the body or the second cover about the axle while holding the other of the body or the second cover so as to uncover the second opening. Moreover, the method may include continuing to hold the attaching device while rotating the body.

According to the method, the rotating act may be performed while the second cover remains stationary relative to a support surface. The method may include discharging a fluid through the cavity from one of the first or second openings to the other of the first or second openings. Additionally, the method may include removing at least a portion of a screen from the cavity (e.g., by rotating the screen about the axle and/or a hinge).

### BRIEF DESCRIPTION OF THE DRAWINGS

Embodiments of the present present system will now be described, by way of example, with reference to the accompanying drawings, wherein:

FIG. 1 is an elevated frontal perspective view of a trash bin in accordance with an embodiment of the present system;

FIG. 2 is a top view of the trash bin with a top portion in an opened position in accordance with an embodiment of the present system;

FIG. 3 is a perspective view of the trash bin with top and bottom portions in an opened position in accordance with an embodiment of the present system;

FIG. 4A is a side view of a trash bin with the bottom portion in the closed position in accordance with an embodiment of the present system;

FIG. 4B is a side view of a trash bin of FIG. 4A with the top portion in the opened position in accordance with an embodiment of the present system;

FIG. 5A is a partially cutaway side view of a trash bin with a rounded body in accordance with an embodiment of the present system;

FIG. 5B is a side view of the trash bin shown in FIG. 5A with the bottom portion in the opened position in accordance with an embodiment of the present system;

FIG. 5C is a side view of the trash bin of FIG. 5A with the bottom portion in the opened position in accordance with an embodiment of the present system;

FIG. 5D is an exploded side view of the trash bin shown in FIG. 5A in accordance with an embodiment of the present system;

FIG. 5E is a bottom plan view of the of the trash bin shown in FIG. 5A in accordance with an embodiment of the present system; and

FIG. 5F is a front plan view of the of the trash bin shown in FIG. 5A in accordance with an embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

Preferred embodiments of the present system will now be described in detail with reference to the drawings. For the sake of clarity, certain features of the present system will not be discussed when they would be apparent to those of ordinary skill in the art.

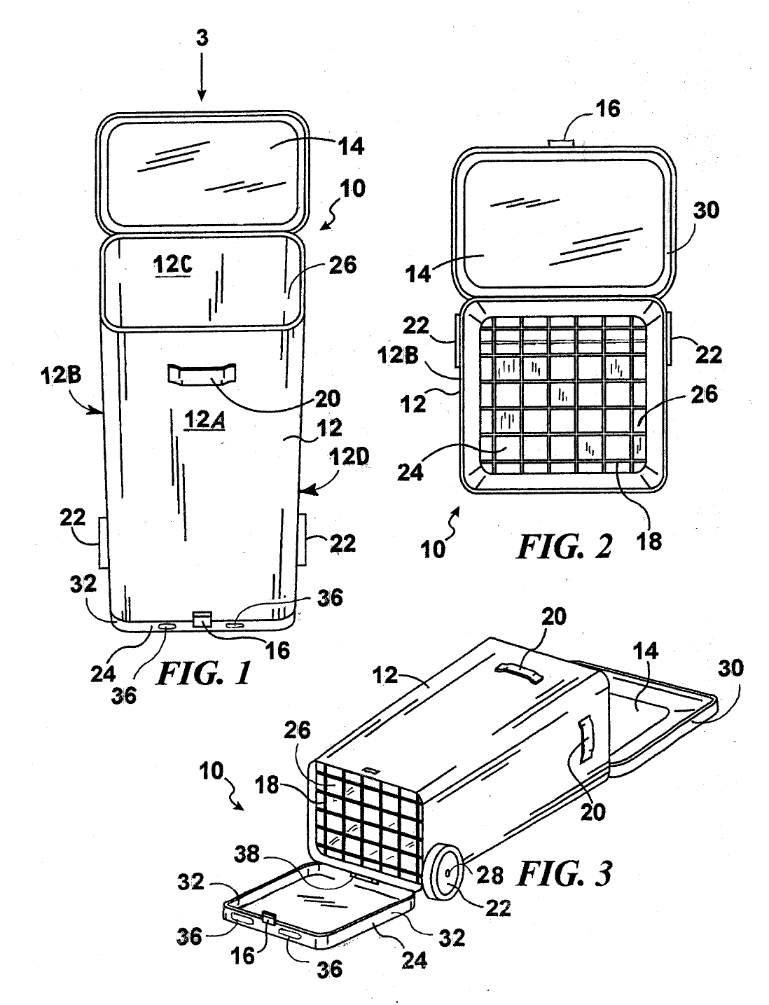

An elevated frontal perspective view of a trash bin according to the present system is shown in FIG. 1. Container 10 includes one or more of a body portion 12, a top portion 14, a bottom portion 24, one or more handles 20, a screen 18, and wheels 22. The container may be formed from any suitable material such as, for example, a metal (e.g., sheet metal), a polymer (e.g.; polyethylene (HDPE), rubber, etc.), and/or combinations thereof.

The body portion 12 defines at least part of a cavity 26 for receiving a desired object such as, for example, household refuse. The body portion 12 includes one or more walls (e.g., 12A-12D) which may be parallel and/or tapered relative to each other. The one or more walls 12A-12D may define at least part of the interior cavity.

The one or more handles 20 are suitable for grasping by a user and may be attached to, or formed integrally with, the one or more walls 12A-12D. Although not shown, the one or more handles 20 may be attached to the one or more walls 12A-12D using any suitable method such as, for example, a threaded connection, a friction fit, a protrusion on either of the handle or corresponding wall portion and a corresponding indentation on an other of the handle or corresponding wall portion, etc. The wheels 22 are shown disposed on opposite sides of the body portion 12 and are suitable for supporting the weight of the container 10 when fully loaded with, for example, household trash.

The top portion 14 may include a handle (not shown) and may be separably and/or hingedly attached to the body portion 12 using any suitable method. The top portion 14 may include a flange 30 which extends around an outer periphery of the top portion 14 and is shaped and sized such that it may be frictionally secured to an upper portion (e.g., a rim) of the body portion 12. Further, the top portion 14 may include at least part of a latching mechanism to further secure the top portion 14 to the body portion 12. As shown, the flange 30 of the top portion 14 is shaped and sized such that it may frictionally fit about the upper part of the body portion 12 so that the top portion 14 does not unintentionally separate (or open) during handling and use. Moreover, although not shown, the top portion 14 may include a handle (suitable for grasping by a user) to aid in the removal (or opening) of the top portion 14.

The bottom portion 24 may include a handle (not shown) and may be separably and/or hingedly attached to the body portion 12 using any suitable method. The bottom portion 24 may include a flange 32 which extends around a lower periphery of the bottom portion 24 and is shaped and sized such that it may be frictionally secured to the lower periphery (e.g., a rim) of the body portion 24. Further, the bottom portion 24 may include at least part of a latching mechanism to further secure the bottom portion 24 to the body portion 12. As shown, the flange 32 of the bottom portion 24 is shaped and sized such that it may frictionally fit about the lower part of the body portion 12. The bottom portion 24 may include one or more latches 16 which are suitable for releasably attaching the bottom portion 24 to the body portion 12 and which may be easily released when desired. The bottom portion 24 may include one or more openings 36 which may provide a desired amount of airflow (e.g., to release a vacuum within the body portion when trash liners are inserted/removed, to provide an amount of aeration to the bottom portion 24) and/or release excess liquid that may be contained by the bottom portion 24.

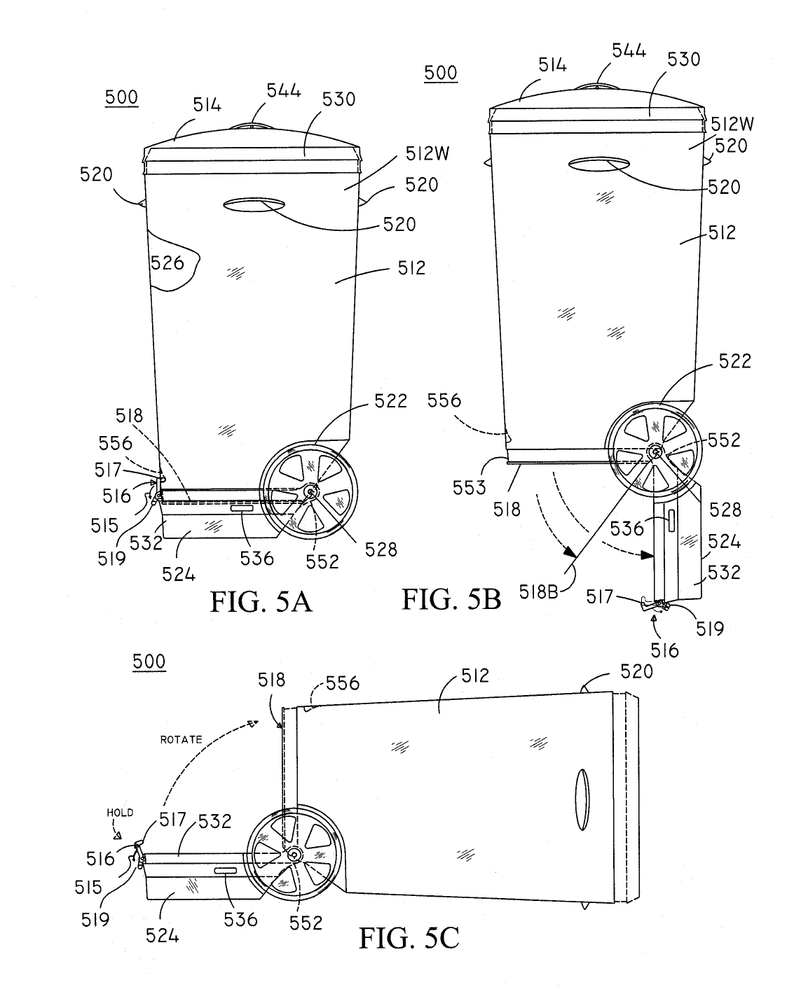

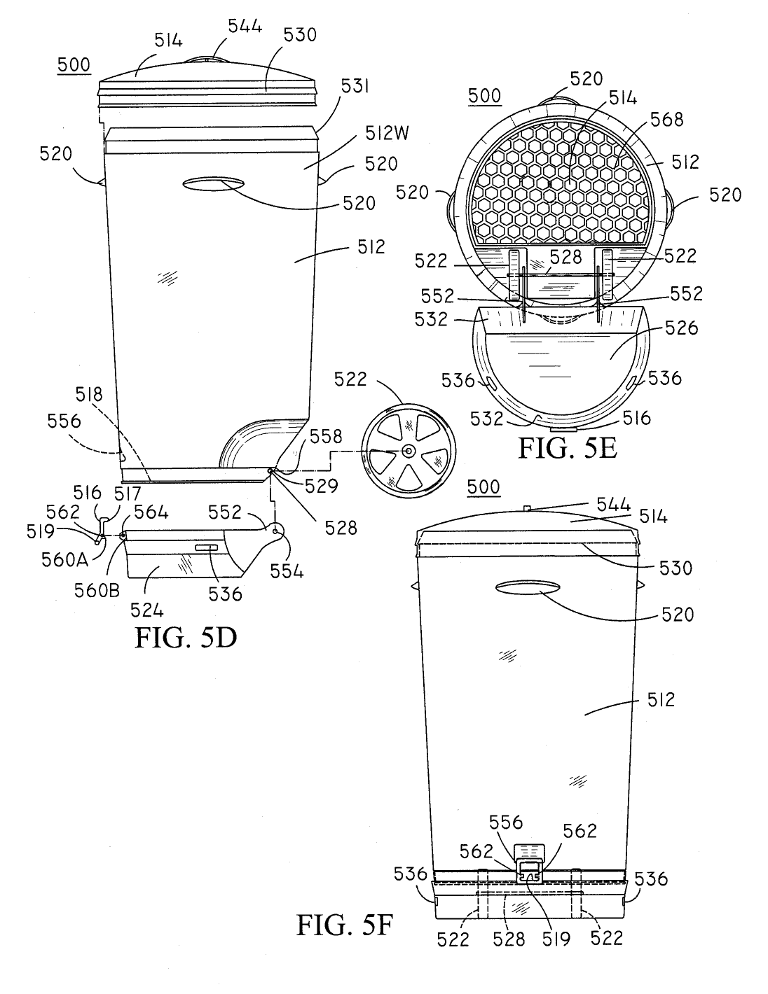

A top view of the trash bin with a bottom portion in an opened position is shown in FIG. 2 in accordance with an embodiment of the present system. As shown, wheels 22 are disposed to either side of the body portion 12. However, it is also envisioned that the wheels 22 may be inwardly disposed such that two or more of the trash bins may be stacked within each other, such as illustratively shown in FIGS. 5.

The screen 18 has openings which are suitable for containing objects of a predetermined size and/or letting objects smaller than the predetermined size pass through and into the lower portion 24. Additionally, liquids and the like may pass through the openings of the screen 18. In use, the bottom portion 24 may contain liquid and/or solid refuse that may pass through the screen 18 and accumulate in the bottom portion 24. The screen 18 may be made from any suitable material (e.g., polymers (e.g., polyethylene), metal, etc.) and may be attached to the body portion 12 using any suitable attachment method. For example, a latch mechanism, a friction fit, a flange, etc., may be used to secure the screen 18 to the body portion 12. Further, it is also envisioned that an axle, which extends between and supports the wheels 22, may support at least part of the screen 18. Moreover, it is also envisioned that the screen 18 may be integrally formed with the body portion 12 and include cutout portions which define the screen 18. In accordance with the present system, the screen 18 is configured to support trash (e.g., that is sized larger than the openings) and/or a trash liner, such that the trash and/or trash liner is maintained above any accumulated refuse and/or liquid that is contained in the bottom portion 24.

A perspective view of the trash bin with top and bottom portions in the opened position is shown in FIG. 3 in accordance with an embodiment of the present system. The bottom portion 24 is illustratively shown hingedly attached to the body portion 12 using any suitable mechanism such as, for example, hinge 38. The latch 16 which may include a latching part is shown fastened to (or formed integrally with) one of the flanges 32 (or other parts) of the bottom portion 24. The flanges 32 of the bottom portion 24 have a sufficient height for retaining a desired amount of fluid. The wheels 22 may be attached to the body portion 12 using any suitable mechanism such as, for example, axle 28 which may support one or more of the wheels 22. Further, the axle may support a part of the screen 18.

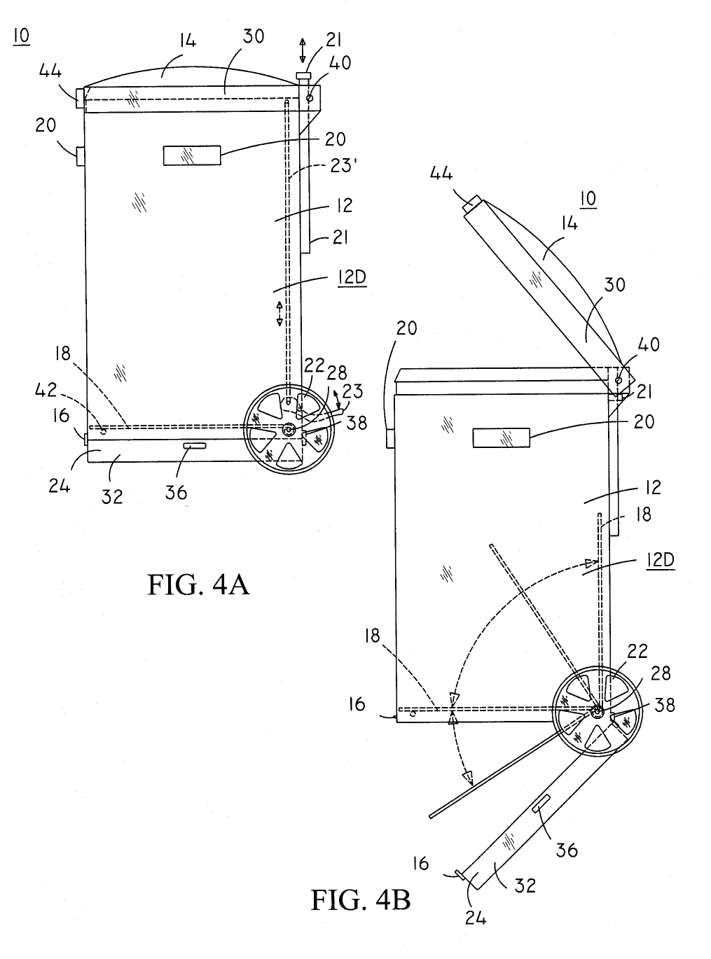

A side view of a trash bin with the bottom portion in the closed position is shown in FIG. 4A in accordance with an embodiment of the present system. The screen 18 is shown illustratively resting upon a support member such as, for example, a flange, a rod (e.g., the axle 28), etc. and may optionally rotate about an axis such as, for example, an axis defined by axle 28. The screen 18 may also be supported by one or more optional support members such as flanges, rods, etc. As shown in FIG. 4A, the one or more optional support members may include one or more rods 42 (or removable support members, etc.) which extend across the cavity 26 of the body portion 12 and are attached to one or more sides (12A-12D) of the body portion 12. Suitable methods for attaching the rods 42 to the body portion 12 include inserting the one or more rods through holes in the one or more sides 12A-12D of the body portion 12 or using flanges to support the rods 42. However, it is also envisioned that flanges may be molded into and/or formed integrally with the body portion 12 so as to directly support one or more sides of the screen 18 and/or optional rods 42. The top portion 14 may include one or more handles 44 suitable for grasping by a user so that the top portion 14 may be opened and/or removed. The top portion 14 may be hingedly attached to the body portion 12 using any suitable mechanism such as, for example, one or more hinges 40. An optional telescoping handle mechanism 21 may be provided and located at any suitable position relative to the body portion 12 such that the container 10 may be easily maneuvered. Moreover, a foot opening mechanism may be provided so as to easily open the top portion 14. For example, the foot opening mechanism may include a foot pedal 23 which may be configured to transmit a force (e.g., from a user's foot) to open the top portion 14, via, for example, a linkage 23′. Accordingly, in this embodiment, a user may depress the foot pedal to open the top portion. Although the foot pedal is shown located in a rear portion of the container 10, the foot pedal may also be located in the sides or front of the container.

A side view of a trash bin of FIG. 4A with the top portion in an opened position is shown in FIG. 4B in accordance with an embodiment of the present system. The top portion 14 may pivot about the hinge 40 so that contents of the trash bin 10 may be removed. The bottom portion 24 may be hingedly attached to the body portion 12 via hinge 38 or other suitable member. The screen 18 may be attached to a hinge member such as axle 28 so that the screen 18 may be pivoted to further aid cleaning of the trash bin 10. For example, the screen 18 may be pivoted and/or removed (e.g., after removing rod 42) such that at least part of the screen lies outside an interior cavity formed by the body portion 12 and/or to provide ready access to a bottom portion of the trash bin. The telescoping handle 21 is shown in a retracted position. For the sake of clarity, the foot opening mechanism is not shown.

A partial cutaway side view of a trash bin with a rounded body is shown in FIG. 5A in accordance with an embodiment of the present system. Container 500 includes one or more of a body portion 512, a top portion 514, a bottom portion 524, one or more handles 520, a screen 518, and wheels 522.

The body portion 512 defines at least part of a cavity 526 for receiving a desired object such as, for example, household refuse. The body portion 512 includes one or more walls 512W which may be parallel and/or tapered relative to each other or to a central axis of the body portion. The one or more walls 512W define at least part of the interior cavity 526.

The one or more handles 520 are suitable for grasping by a user and may be attached to, or formed integrally with, the one or more walls 512W. Although not shown, the one or more handles 520 may be attached to the one or more walls 512W using any suitable method such as, for example, a threaded connection, a friction fit, a protrusion and a corresponding indentation, etc.

The wheels 522 are disposed on opposite sides of the body portion 512 and are suitable for supporting the weight of the container 500 when fully loaded with, for example, household trash. The wheels 522 may be positioned such that one or more containers 500 may be stacked within at least part of each other for storage and/or shipping, etc.

The top portion 514 may include a handle 544 and may be separably and/or hingedly attached to the body portion 512 using any suitable method. The top portion 514 may include a flange 530 which extends around an outer periphery of the top portion 514 and is shaped and sized such that it may be frictionally secured to an upper portion (e.g., a rim such as rim 531 shown in FIG. 5E) of the body portion 512. Further, the top portion 514 may include at least part of a latching mechanism to further secure the top portion 514 to the body portion 512. The handle 544 may be suitable for grasping and removal (or opening) the top portion 514 relative to the body portion 512. However, it is also envisioned that the handles or other holding device may be suitable for manipulation by a robotic mechanism for automated garbage disposal as may be used by automated garbage loaders in sanitation trucks.

The bottom portion 524 may include a handle and may be separably and/or hingedly attached to the body portion 512 using any suitable method. The bottom portion 524 may include a flange 532 which extends around at least part of a lower periphery of the bottom portion 524 and is shaped and sized such that it may be frictionally secured to the lower periphery (e.g., a rim 533, as illustratively shown in FIG. 5B) of the body portion 512, if desired. Further, the bottom portion 524 may include at least part of a latching mechanism (which may include the latch 516) to further secure the bottom portion 524 to the body portion 512. As shown the flange 532 of the bottom portion 524 is shaped and sized such that it may frictionally fit about the lower part of the body portion 512. In use, the bottom portion 524 may accumulate liquid and/or solid refuse that passes through the screen 518. The bottom portion 524 may include one or more latches 516 which are suitable for releasably attaching the bottom portion 524 to the body portion 512 and which may be released when properly actuated. The bottom portion may include one or more openings 536 which may provide a desired amount of airflow (e.g., to release a vacuum within the body portion 512 when a trash liner is removed, to provide an amount of aeration to the bottom portion 524) and/or release excess liquid that may be accumulated in the bottom portion 524.

The screen 518 may be formed integrally with the body portion 512 and includes a plurality of openings. However, it is also envisioned that the screen 518 may be separate from the body portion 512 and may be removed from the body portion 512. Further, it is also envisioned that the screen 518 may include a plurality of screens (e.g., see, screen 518 and/or screen 518B), that may be separated by a gap therebetween, each of which may include the same or different sized apertures, for enabling a sifting of any material that may pass through the plurality of screens . Moreover, it is also envisioned that the screen (or screens) may be held in position by one or more fixed and/or removable flanges or other devices (e.g., hinges and/or latches) suitable for fixing the one or more screens in place. Accordingly, it is envisioned that the screen may be removed and/or hingedly rotated so that at least a portion of the screen may be located outside of a cavity defined by the body portion so that the screen and/or body portion of the trash bin may be easily cleaned.

A side view of the trash bin shown in FIG. 5A with the bottom portion in the opened position is shown in FIG. 5B in accordance with an embodiment of the present system. The bottom portion 524 may be hingedly and/or releasably attached to the body portion 512 using any suitable mechanism. For example, the bottom portion 524 may include one or more holes 554 which may be located about at least part of an axle 528. For example, in one embodiment in accordance with the present system, the bottom part 524 may rotate about an axis defined by the axle 528. The bottom portion 524 may include a latching mechanism such as one or more latches 516 attached to a flange 532 of the bottom portion 524. The flange 532 has a sufficient height for retaining an amount of fluid that may accumulate in the bottom portion 524. The wheels 522 may be attached to the body portion 512 using any suitable mechanism such as, for example, the axle 550 which may support one or more of the wheels 522. Further, the axle may support a part of the screen (e.g., screen 518 and/or screen 518B) if desired.

A side view of the trash bin of FIG. 5A with the bottom portion in the opened position is shown in FIG. 5C, in accordance with an embodiment of the present system. The latch 516 comprises a latch portion 517 and a release portion 519. The latch portion 517 may be shaped and sized so as to engage a latch flange 556 on the body portion 512. To release the latch 516, the release portion 519 of the latch 516 may be depressed, such as by a foot of a user, so as to rotate the latch 516 in the direction of arrow 515 and separate the latch portion 517 from the latch flange 556.

Advantageously, the latch 516 may be depressed, for example by the user's foot, and the body portion 512 may be rotated away from the latch 516 to facilitate separation (e.g., a hingable separation) of the bottom portion 524 from the body portion 512. Further, the bottom portion 524 may be configured (e.g., sized and/or shaped) to rest on a supporting surface (e.g., the ground) during separation of the bottom portion 524 from the body portion 512. In this way, not only may the bottom portion 524 be separated from the body portion 512, but in addition, any liquid and/or refuse in the bottom portion 524, may be retained in the bottom portion 524 during the separation process. Further, in an embodiment wherein a plurality of screens is present, the plurality of screens may be retained within the trash bin utilizing different retaining mechanisms. For example, in one embodiment one of the plurality of screens may be retained by a flange, etc., in the body portion 512 while another of the plurality of screens may be retained by the axel 528 and/or flange 532.

An exploded side view of the trash bin shown in FIG. 5A is shown in FIG. SD in accordance with an embodiment of the present system. A support area 558 includes an axle retaining area 529 which locates the axle 528 such that the axle 528 does not separate from the trash bin 500 during use. For example the axle retaining area 529 may include flanges which are molded into the body portion 512 and wrap around at least part of the axle 528 and may exert a frictional force against the axle 528 such that the axle 528 remains in a desired position relative to the body portion 512. The bottom portion 524 may be hingedly and optionally removably, attached to the body portion 512 using any suitable attaching mechanism. For example, the bottom part 524 may include mounting flanges 552 each of which may include holes 554 for receiving the axle 528. Accordingly, the bottom part 514 may rotate about an axis defined by the axle 528. The wheels 522 may be fastened to the axle 528 using any suitable mechanism. For example, an axle cap or other retaining member (e.g., a cotter pin, a nut, etc.) may be used to fasten the wheels 522 to the axle 528. The latch 516 (or portions thereof) may be attached to the bottom part 524 using any suitable means. For example, the latch 516 may include one or more mounting tabs 562 (better illustrated with respect to FIG. 5F) which engage mounting holes 564 in the bottom part 524 which may be shaped and sized so as to receive the mounting tabs 562. An optional biasing member may provide a force suitable for holding the latch 516 in a desired position (e.g., closed, open, etc.) when in a closed and/or open position. A suitable biasing member may include a cam member 560A which exerts a force against a receiving surface 560B of the bottom part 514 and biases or otherwise urges the latch 516 in, for example, a closed position when the latch portion 517 engages the latch flange 556 (e.g., when the bottom portion 514 is in a closed position).

A bottom plan view of the of the trash bin shown in FIG. 5A is shown in FIG. 5E in accordance with an embodiment of the present system. The screen 518 may be include holes having any suitable size and/or shape (e.g., square, rectangular, round, hexagonal, and combinations thereof) so as to define any suitable pattern in the screen 518. For example, as shown in FIG. 5E, the holes may have a shape so as to define a honeycomb pattern in the screen 518. Further, the screen may include a composite structure (e.g., be formed from two materials which may be dissimilar) and include, for example, a reinforcing member such as a steel insert.

A front plan view of the of the trash bin shown in FIG. 5A is shown in FIG. 5F in accordance with an embodiment of the present system. The release portion 519 may be shaped and/or sized (e.g., include a saddle portion) such that a user may easily depress (e.g., with a user's foot) the release portion 519 and release the latch 516 when the bottom part 524 is in a closed position.

The screen may be separated from the bottom of the bottom portion of the trash bin such that trash (or other materials) contained in the trash bin may be separated from liquids which may be present in the bottom portion of the container.

Thus, according to the present system, a low-cost, stable, and easily sanitized trash bin that may be easily used and cleaned is provided.

Certain additional advantages and features of this present system may be apparent to those skilled in the art upon studying the disclosure, or may be experienced by persons employing the novel system and method of the present system, chief of which is that a sanitary and easily cleaned trash receptacle in which fluids may be easily removed is provided. Another advantage of the present system is that conventional trash bin may be easily modified to incorporate the features and advantages of the present system.

While the present system has been described with a limited number of embodiments, it will be appreciated that changes may be made without departing from the scope of the original claimed present system, and it is intended that all matter contained in the foregoing specification and drawings be taken as illustrative and not in an exclusive sense.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) several “structures” may be represented by the same designated item or hardware structure;
d) any of the disclosed structures or portions thereof may be combined together or separated into further portions unless specifically stated otherwise;
e) no specific sequence of acts or steps is intended to be required unless specifically indicated; and
f) the term “plurality of” an element includes two or more of the claimed element, and does not imply any particular range of number of elements; that is, a plurality of elements may be as few as two elements, and may include an immeasurable number of elements.

What is claimed is:

1. A refuse receptacle apparatus, comprising:
a first part having one or more walls defining at least part of a first cavity, a longitudinal axis, and first and second openings situated opposite each other such that the longitudinal axis passes through the first and second openings;
a second part having one or more walls defining at least part of a second cavity and configured to support at least part of the first part and to cover the second opening; and
a screen situated between the first and second cavities and supported by the first or second parts.

2. The apparatus of claim 1, wherein the screen is hingedly attached to the first or second parts.

3. The apparatus of claim 1, further including:
an axle attached to the first part; and
one or more wheels attached to the axle.

4. The apparatus of claim 3, wherein the screen rotates about an axis of the axle.

5. The apparatus of claim 1, further comprising a holding member attached to the first or second parts and which supports at least part of the screen.

6. The apparatus of claim 5, wherein the holding member comprises a rod which is attached to the first part.

7. The apparatus of claim 1, further comprising a cover configured to cover the first opening.

8. The apparatus of claim 1, further comprising at least one latch which releasably secures the second part in a closed position relative to the first part.

9. The apparatus of claim 1, wherein the latch comprises a saddle which is depressed to release the first and second parts from each other.

10. The apparatus of claim 7, further comprising a foot pedal which may transmit a force for opening the cover.

11. A receptacle apparatus, comprising:
a first part having one or more walls defining at least part of a first cavity, a longitudinal axis, and first and second openings situated opposite each other such that the longitudinal axis passes through the first and second openings;
a second part hingedly attached to the first part and having one or more walls defining at least part of a second cavity, the second part being configured to support at least part of the first part and to cover the second opening;
a screen attached to the first part; and
a latch attached to one or more of the first and second parts and is configured to hold the second part in a closed position relative to the first part.

12. The apparatus of claim 11, wherein the one or more walls of the first part define a taper in the first part such that the second opening is smaller than the first opening.

13. The apparatus of claim 12, further comprising a vent hole situated in the one or more walls of the second part.

14. The apparatus of claim 11, further comprising:
an axle attached to the first part;
wheels attached to the axle; and
a saddle configured to support the axle, the saddle being situated at least in part between the wheels and formed at least in part integrally with the first part.

15. A method for cleaning a trash bin having a body supported by a plurality of wheels mounted to an axle, the body defining a cavity having first and second openings located opposite each other, and first and second covers which respectively cover first and second openings, the method comprising the acts of:
depressing an attaching device which releasably attaches the second cover to the body so as to release the body portion from the second cover; and
rotating the body or the second cover about an axle while holding the other of the body or the second cover so as to uncover the second opening.

16. The method of claim 15, further comprising continuing to hold the attaching device while rotating the body.

17. The method of claim 15, wherein the rotating is performed while the second cover remains stationary relative to a support surface.

18. The method of claim 15, further comprising flowing a fluid through the cavity from one of the first or second openings to the other of the first or second openings.

19. The method of claim 15, further comprising removing at least a portion of a screen from the cavity.
